(19) United States
(12) Patent Application Publication
(10) Pub. No.: US 2018/0203736 A1
(43) Pub. Date: Jul. 19, 2018

(54) AFFINITY BASED HIERARCHICAL CONTAINER SCHEDULING

(71) Applicant: Red Hat, Inc., Raleigh, NC (US)

(72) Inventors: Jay Vyas, Concord, MA (US); Huamin Chen, Westborough, MA (US); Timothy Charles St. Clair, Middleton, WI (US)

(21) Appl. No.: 15/405,900

(22) Filed: Jan. 13, 2017

(51) Int. Cl. G06F 9/50; G06F 9/455

(52) U.S. Cl. CPC G06F 9/5033; G06F 9/45558; G06F 2209/501; G06F 2009/4557; G06F 9/5077

(57) ABSTRACT

Affinity based hierarchical container scheduling is disclosed. For example, a hierarchical map identifies relationships between a plurality of nodes and hardware devices, subzones, and zones. Affinity values of containers of a distributed service are measured, quantifying the containers' hierarchical relationship to other containers. A first affinity distribution of the distributed service is calculated based on affinity values, then used to calculate a first value of a performance metric of the distributed service. The value is iteratively adjusted by repeatedly: terminating and redeploying containers; measuring affinity values; calculating a new affinity distribution; and calculating a new value of the performance metric of the distributed service configured in the new affinity distribution, such that second and third values of the performance metric corresponding to second and third affinity distributions are calculated. Based on determining that the third value is highest, and deploying the distributed service based on the third affinity distribution.

### BACKGROUND

The present disclosure generally relates to deploying isolated guests in a network environment. In computer systems, it may be advantageous to scale application deployments by using isolated guests such as virtual machines and containers that may be used for creating hosting environments for running application programs. Typically, isolated guests such as containers and virtual machines may be launched to provide extra compute capacity of a type that the isolated guest is designed to provide. Isolated guests allow a programmer to quickly scale the deployment of applications to the volume of traffic requesting the applications. Isolated guests may be deployed in a variety of hardware environments. There may be economies of scale in deploying hardware in a large scale. To attempt to maximize the usage of computer hardware through parallel processing using virtualization, it may be advantageous to maximize the density of isolated guests in a given hardware environment, for example, in a multi-tenant cloud. In many cases, containers may be leaner than virtual machines because a container may be operable without a full copy of an independent operating system, and may thus result in higher compute density and more efficient use of physical hardware. Multiple containers may also be clustered together to perform a more complex function than the containers are capable of performing individually. A scheduler may be implemented to allocate containers and clusters of containers to a host node, the host node being either a physical host or a virtual host such as a virtual machine. Depending on the functionality of a container or system of containers, there may be advantages for different types of deployment schemes.

### SUMMARY

The present disclosure provides a new and innovative system, methods and apparatus for affinity based hierarchical container scheduling. In an example, a plurality of containers are deployed on a plurality of nodes including a first node and a second node. The first node is associated with a first hardware device, which is associated with a first subzone, which is associated with a first zone, and the second node is associated with a second hardware device, which is associated with a second subzone, which is associated with a second zone. The plurality of containers, including a first container and a second container, is configured to deliver a first distributed service. A scheduler executes on one or more processors to build a hierarchical map of the system by identifying a hierarchical relationship between each node of the plurality of nodes and a respective hardware device, a respective subzone and a respective zone associated with each node of the plurality of nodes. A first affinity value of the first container is measured, quantifying the first container's hierarchical relationship to other containers of the plurality of containers. A second affinity value of the second container is measured quantifying the second container's hierarchical relationship to other containers of the plurality of containers. A first affinity distribution of the first distributed service is calculated based on a first plurality of affinity values including at least the first affinity value and the second affinity value. A first value of a performance metric of the first distributed service while configured in the first affinity distribution is calculated.

The first value of the performance metric is iteratively adjusted by repeatedly: (i) terminating containers of the plurality of containers including the first container and the second container; (ii) redeploying containers of the plurality of containers including the first container and the second container; (iii) measuring affinity values of the plurality of containers including at least a first new affinity value of a first redeployed container and a second new affinity value of a second redeployed container; (iv) calculating a new affinity distribution of the plurality of containers; and (v) calculating a new value of the performance metric of the first distributed service while configured in a new affinity distribution. In the iterative adjustment process, at least a second value of the performance metric and a third value of the performance metric of the first distributed service are calculated, where the second value of the performance metric corresponds to a second affinity distribution and the third value of the performance metric corresponds to a third affinity distribution. It is determined whether the third value of the performance metric is higher than the first value of the performance metric and the second value of the performance metric. Responsive to determining that the third value of the performance metric is higher than the first value of the performance metric and the second value of the performance metric, the first distributed service is deployed based on the third affinity distribution.

Additional features and advantages of the disclosed method and apparatus are described in, and will be apparent from, the following Detailed Description and the Figures.

### BRIEF DESCRIPTION OF THE FIGURES

FIG. 1 is a block diagram of a system employing affinity based hierarchical container scheduling according to an example of the present disclosure.

FIG. 2 is a block diagram of a hierarchical map of a system employing affinity based hierarchical container scheduling according to an example of the present disclosure.

FIG. 3 is a flowchart illustrating an example of affinity based hierarchical container scheduling according to an example of the present disclosure.

FIG. 4 is a flow diagram illustrating an example system employing affinity based hierarchical container scheduling according to an example of the present disclosure.

FIG. 5 is a block diagram of an example system employing affinity based hierarchical container scheduling according to an example of the present disclosure.

### DETAILED DESCRIPTION OF EXAMPLE EMBODIMENTS

In computer systems utilizing isolated guests, typically, virtual machines and/or containers are used. In an example, a virtual machine (“VM”) may be a robust simulation of an actual physical computer system utilizing a hypervisor to allocate physical resources to the virtual machine. In some examples, container based virtualization system such as Red Hat® OpenShift® or Docker® may be advantageous as container based virtualization systems may be lighter weight than systems using virtual machines with hypervisors. In the case of containers, oftentimes a container will be hosted on a physical host or virtual machine, sometimes known as a node, that already has an operating system executing, and the container may be hosted on the operating system of the physical host or a VM. In large scale implementations, container schedulers such as Kubernetes®, generally respond to frequent container startups and cleanups with low latency. System resources are generally allocated before isolated guests start up and released for re-use after isolated guests exit. Containers may allow for wide spread, parallel deployment of computing power for specific tasks.

Due to economies of scale, containers tend to be more advantageous in large scale hardware deployments where the relatively fast ramp-up time of containers allows for more flexibility for many different types of applications to share computing time on the same physical hardware, for example, in a private or multi-tenant cloud environment. In some examples, especially where containers from a homogenous source are deployed, it may be advantageous to deploy containers directly on physical hosts. In such examples, the virtualization cost of virtual machines may be avoided, as well as the cost of running multiple operating systems on one set of physical hardware. In a multi-tenant cloud, it may be advantageous to deploy groups of containers within virtual machines as the hosting service may not typically be able to predict dependencies for the containers such as shared operating systems, and therefore, using virtual machines adds flexibility for deploying containers from a variety of sources on the same physical host. However, as environments get larger, the number of possible host nodes such as physical servers and VMs grows, resulting in an ever larger number of possible destinations for a scheduler responsible for deploying new containers to search through for an appropriate host for a new container. In an example, there may be advantages to deploying a given container to one node over another, but the proper distribution and density of containers for a given distributed service may not be readily apparent to a scheduler or a user. For a given container in a large environment, there may be hundreds or thousands of possible nodes that have the physical capacity to host the container. In an example, a scheduler may treat nodes as fungible commodities, deploying a given container to the first node with the capacity to host the container, or a random node with sufficient capacity to host the container. In an example, simplifying a scheduler's decision making process may improve the performance of the scheduler, allowing for higher throughput container scheduling. However, by commoditizing nodes, synergies available from hosting related containers in close proximity hierarchically may be lost. For example, sharing a hardware host or node may allow containers to share libraries already loaded to memory and reduce network latency when passing data between containers. Hierarchy unaware deployments may also fail to adequately distribute containers providing a service resulting in high latency for clients located far away from the nodes hosting the distributed service.

The present disclosure aims to address the problem of properly distributing containers by employing affinity based hierarchical container scheduling. In an example, a container scheduler practicing affinity based hierarchical container scheduling may recursively inspect affinity topology for determining service optimization. By mapping the hierarchical relationships of each node capable of hosting a container to other candidate nodes in a system, an affinity value may be calculated between containers deployed to any given nodes. Using a quantitative value to represent these hierarchical affinity relationships allows for the representation of a deployment scheme for a distributed service as an affinity distribution that is representative of the relationship between the various containers providing the distributed service. In an example where hardware specifications for various nodes are comparable, the affinity distribution for a deployment may then be informative regarding a value of a performance metric of the distributed service, and therefore, future deployments of the same distributed service with a similar affinity distribution may predictably yield similar performance results even if the containers are deployed to different nodes. For example, if four containers deployed to a first node result in a certain level of performance, then four equivalent containers deployed to a second node with equivalent hardware specifications to the first node should yield a similar level of performance to the first four containers. Similarly, four containers spread among two nodes on the same hardware device should perform similarly to four identical containers spread among two nodes of a different hardware device. Therefore, by iteratively testing different affinity distributions for a given distributed service to increase the value of the performance metric of the distributed service, a preferable affinity distribution for the deployment of the distributed service may be found that may be a framework for future deployments of additional containers and additional copies of the distributed service.

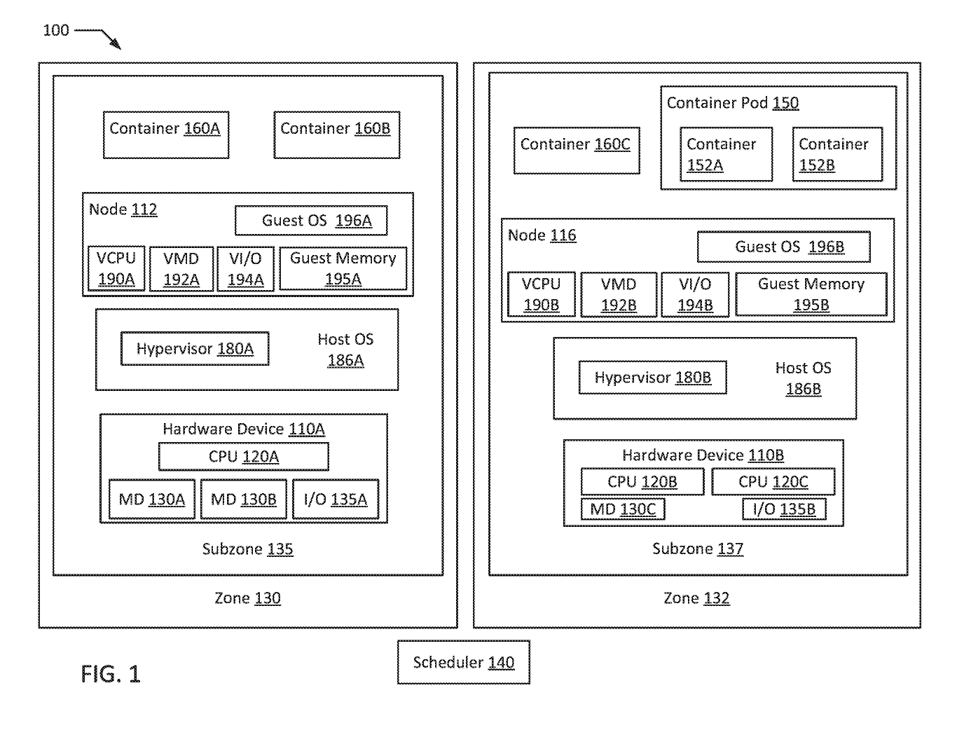

FIG. 1 is a block diagram of a system employing affinity based hierarchical container scheduling according to an example of the present disclosure. The system 100 may include one or more interconnected hardware devices 110A-B. Each hardware device 110A-B may in turn include one or more physical processors (e.g., CPU 120A-C) communicatively coupled to memory devices (e.g., MD 130A-C) and input/output devices (e.g., I/O 135A-B). As used herein, physical processor or processors 120A-C refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU).

As discussed herein, a memory device 130A-C refers to a volatile or non-volatile memory device, such as RAM, ROM, EEPROM, or any other device capable of storing data. As discussed herein, I/O device 135A-B refers to a device capable of providing an interface between one or more processor pins and an external device, the operation of which is based on the processor inputting and/or outputting binary data. Processors (Central Processing Units “CPUs”) 120A-C may be interconnected using a variety of techniques, ranging from a point-to-point processor interconnect, to a system area network, such as an Ethernet-based network. Local connections within each hardware device 110A-B, including the connections between a processor 120A and a memory device 130A-B and between a processor 120A and an I/O device 135A may be provided by one or more local buses of suitable architecture, for example, peripheral component interconnect (PCI).

In an example, system 100 may include one or more zones, for example zone 130 and zone 132, as well as one or more subzones in each zone, for example, subzone 135 and subzone 137. In an example, zones 130 and 132 and subzones 135 and 137 are physical locations where hardware devices 110A-B are hosted. In an example, zone 130 may be a large geopolitical or economic region (e.g., Europe, the Middle East, and Africa (“EMEA”)), a continent (e.g., North America), a country (e.g., United States), a region of a country (e.g., Eastern United States), a state or province (e.g., New York or British Columbia), a city (e.g., Chicago), a particular data center, or a particular floor or area of a data center. In an example, subzone 135 may be a physical location that is at least one level more specific than zone 130. For example, if zone 130 is North America, subzone 135 may be the United States. If zone 130 is a New York City, subzone 135 may be a datacenter building in close proximity to New York City (e.g., a building in Manhattan, N.Y., or in a warehouse in Secaucus, N.J.). If zone 130 is a datacenter building, subzone 135 may be a floor of the data center, or a specific rack of servers in the datacenter building. In an example, hardware device 110A may be a server or a device including various other hardware components within subzone 135. In an example, additional hierarchical layers may be present that are larger than zone 130 or of an intermediate size between zone 130 and subzone 135. Similarly, additional hierarchical layers may exist between subzone 135 and hardware device 110A (e.g., a rack).

In an example, hardware devices 110A-B may run one or more isolated guests, for example, containers 152A-B and 160A-C may all be isolated guests. In an example, any one of containers 152A-B, and 160A-C may be a container using any form of operating system level virtualization, for example, Red Hat® OpenShift®, Docker® containers, chroot, Linux®-VServer, FreeBSD® Jails, HP-UX® Containers (SRP), VMware ThinApp®, etc. Containers may run directly on a hardware device operating system or run within another layer of virtualization, for example, in a virtual machine. In an example, containers 152A-B are part of a container pod 150, such as a Kubernetes® pod. In an example, containers that perform a unified function may be grouped together in a cluster that may be deployed together (e.g., in a Kubernetes® pod). In an example, containers 152A-B may belong to the same Kubernetes® pod or cluster in another container clustering technology. In an example, containers belonging to the same cluster may be deployed simultaneously by a scheduler 140, with priority given to launching the containers from the same pod on the same node. In an example, a request to deploy an isolated guest may be a request to deploy a cluster of containers such as a Kubernetes® pod. In an example, containers 152A-B and container 160C may be executing on node 116 and containers 160A-B may be executing on node 112. In another example, the containers 152A-B, and 160A-C may be executing directly on hardware devices 110A-B without a virtualized layer in between.

System 100 may run one or more nodes 112 and 116, which may be virtual machines, by executing a software layer (e.g., hypervisors 180A-B) above the hardware and below the nodes 112 and 116, as schematically shown in FIG. 1. In an example, the hypervisors 180A-B may be components of the hardware device operating systems 186A-B executed by the system 100. In another example, the hypervisors 180A-B may be provided by an application running on the operating systems 186A-B, or may run directly on the hardware devices 110A-B without an operating system beneath it. The hypervisors 180A-B may virtualize the physical layer, including processors, memory, and I/O devices, and present this virtualization to nodes 112 and 116 as devices, including virtual processors 190A-B, virtual memory devices 192A-B, virtual I/O devices 194A-B, and/or guest memory 195A-B. In an example, a container may execute on a node that is not virtualized by, for example, executing directly on host operating systems 186A-B.

In an example, a node 112 may be a virtual machine and may execute a guest operating system 196A which may utilize the underlying virtual central processing unit (“VCPU”) 190A, virtual memory device (“VMD”) 192A, and virtual input/output (“VI/O”) devices 194A. One or more containers 160A and 160B may be running on a node 112 under the respective guest operating system 196A. Processor virtualization may be implemented by the hypervisor 180 scheduling time slots on one or more physical processors 120A-C such that from the guest operating system's perspective those time slots are scheduled on a virtual processor 190A.

A node 112 may run on any type of dependent, independent, compatible, and/or incompatible applications on the underlying hardware and host operating system 186A. In an example, containers 160A-B running on node 112 may be dependent on the underlying hardware and/or host operating system 186A. In another example, containers 160A-B running on node 112 may be independent of the underlying hardware and/or host operating system 186A. Additionally, containers 160A-B running on node 112 may be compatible with the underlying hardware and/or host operating system 186A. In an example, containers 160A-B running on node 112 may be incompatible with the underlying hardware and/or OS. In an example, a device may be implemented as a node 112. The hypervisor 180A manages memory for the hardware device operating system 186A as well as memory allocated to the node 112 and guest operating systems 196A such as guest memory 195A provided to guest OS 196A. In an example, node 116 may be another virtual machine similar in configuration to node 112, with VCPU 190B, VMD 192B, VI/O 194B, guest memory 195B, and guest OS 196B operating in similar roles to their respective counterparts in node 112. The node 116 may host container pod 150 including containers 152A and 152B and container 160C.

In an example, scheduler 140 may be a container orchestrator such as Kubernetes® or Docker Swarm®. In the example, scheduler 140 may be in communication with both hardware devices 110A-B. In an example, the scheduler 140 may load image files to a node (e.g., node 112 or node 116) for the node (e.g., node 112 or node 116) to launch a container (e.g., container 152A, container 152B, container 160A, container 160B, or container 160C) or container pod (e.g., container pod 150). In some examples, scheduler 140, zone 130 and zone 132 may reside over a network from each other, which may be, for example, a public network (e.g., the Internet), a private network (e.g., a local area network (LAN) or wide area network (WAN)), or a combination thereof.

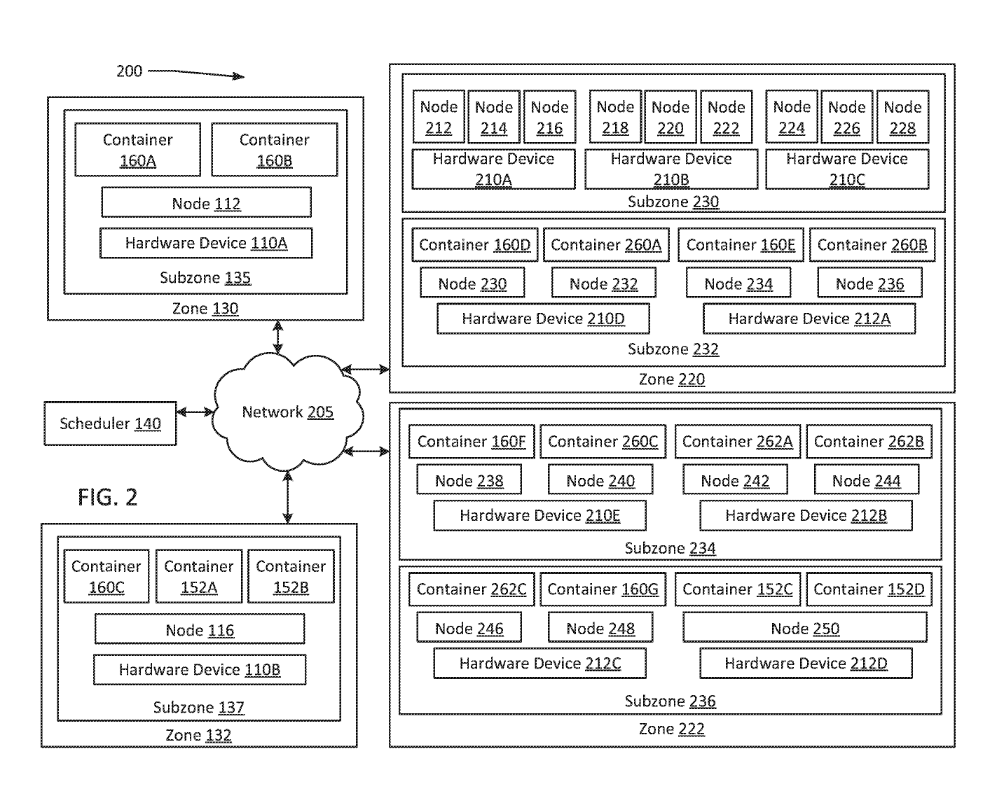

FIG. 2 is a block diagram of a hierarchical map of a system 200 employing affinity based hierarchical container scheduling according to an example of the present disclosure. In an example, scheduler 140 may be a scheduler responsible for deploying containers (e.g., containers 152A-D, 160A-G, 260A-C, 262A-C) to nodes (e.g., nodes 112, 116, 212, 214, 216, 218, 220, 222, 224, 226, 228, 230, 232, 234, 236, 238, 240, 242, 244, 246, 248, and 250) to provide a variety of distributed services. In an example, containers 152A-D may pass data among each other to provide a distributed service, such as delivering advertisements. In an example, containers 160A-G may be copies of the same container delivering a search functionality for a website. In an example, nodes 112, 116, 212, 214, 216, 218, 220, 222, 224, 226, 228, 230, 232, 234, 236, 238, 240, 242, 244, 246, 248, and 250 execute on hardware devices 110A-B, 210A-E, and 212A-D. In an example, hardware devices 110A-B may have the same specifications, hardware devices 210A-E may have the same specifications as each other, but different from hardware devices 110A-B, and hardware devices 212A-D may have a third set of specifications. In an example, all of the components in system 200 may communicate with each other through network 205.

In an example, zone 130 may represent Houston, zone 132 may represent Chicago, zone 220 may represent San Francisco, and zone 222 may represent New York. In another example, zones 130, 132, 220 and 222 may represent continents (e.g., North America, South America, Europe and Asia) or zones 130, 132, 220 and 222 may represent regions of the United States. In an example, subzone 135 may represent a Houston datacenter building, subzone 137 may represent a Chicago datacenter building, subzone 230 may represent a Secaucus, N.J. datacenter building, subzone 232 may represent a Manhattan, N.Y. datacenter building, subzone 234 may represent a Silicon Valley datacenter building, and subzone 236 may represent a Oakland, Calif. datacenter building. In an example, each of hardware devices 110A-B, 210A-E, and 212 A-D may be a server hosted in the subzone each respective hardware device is schematically depicted in. In an example, each node of nodes 112, 116, 212, 214, 216, 218, 220, 222, 224, 226, 228, 230, 232, 234, 236, 238, 240, 242, 244, 246, 248, and 250 may be described as a function of the node's respective parents (e.g., node 112 is hosted on hardware device 110A located in subzone 135 of zone 130).

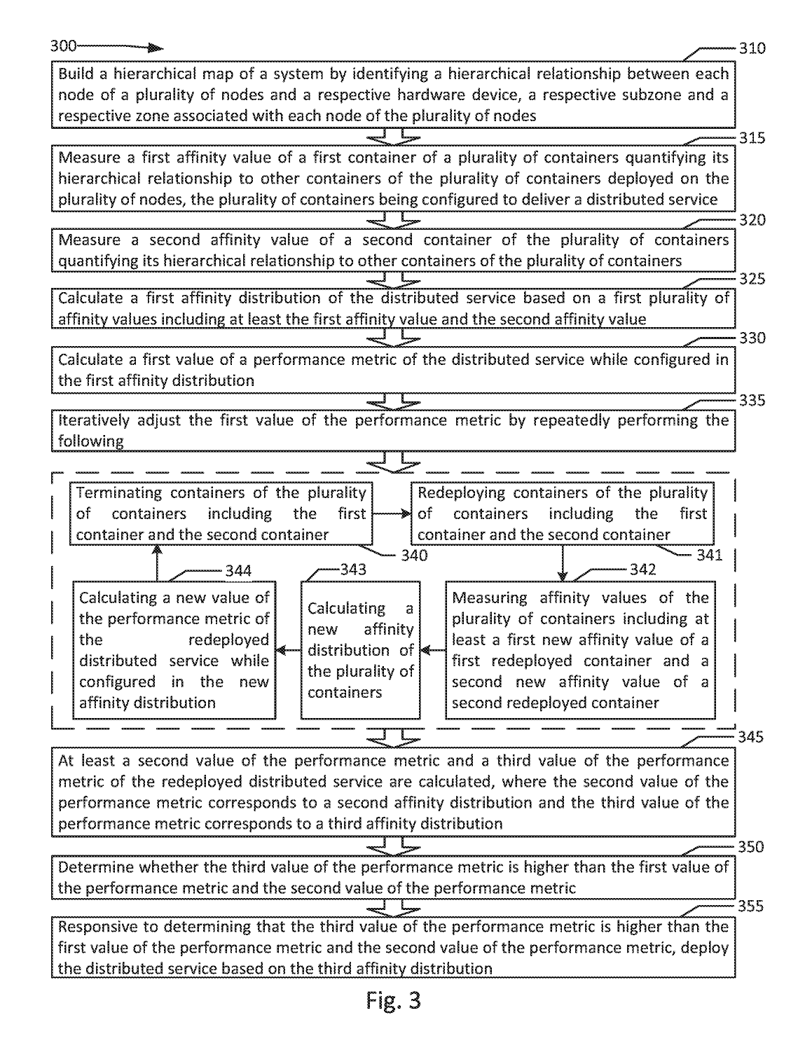

FIG. 3 is a flowchart illustrating an example of affinity based hierarchical container scheduling according to an example of the present disclosure. Although the example method 300 is described with reference to the flowchart illustrated in FIG. 3, it will be appreciated that many other methods of performing the acts associated with the method 300 may be used. For example, the order of some of the blocks may be changed, certain blocks may be combined with other blocks, and some of the blocks described are optional. The method 300 may be performed by processing logic that may comprise hardware (circuitry, dedicated logic, etc.), software, or a combination of both. In an example, the method is performed by scheduler 140.

A hierarchical map of a system is built by identifying a hierarchical relationship between each node of a plurality of nodes and a respective hardware device, a respective subzone and a respective zone associated with each node of the plurality of nodes (block 310). In an example, the scheduler 140 builds a hierarchical map of the system. For example, the scheduler 140 may recursively discover the parent of each layer of a system. In an example, container 160A may report that it is hosted on node 112, which may report that it is hosted on hardware device 110A, which reports that it is located in subzone 135, which reports that it is in turn located in zone 130. In an example, the scheduler 140 identifies that node 112, hardware device 110A, subzone 135, and zone 130 are associated with container 160A by querying metadata associated with container 160A, or by using the hostname or IP address of container 160A. In an example, the hostname of container 160A may include a naming scheme that identifies the parents of container 160A (e.g., C160_N112_HD110A_SZ135_Z130). In another example, the hostname or IP address of container 160A may be used to query a database including the relationship data requested by the scheduler 140. In an example, the scheduler 140 may maintain an up-to-date hierarchical map of all containers and nodes in the system 200. In another example, scheduler 140 may only track available nodes for deploying containers. In some examples, scheduler 140 may create and store hierarchical maps from the perspective of a distributed service including the deployed locations of any containers associated with the distributed service. In an example, the hierarchical map may be searched at any level to discover containers matching a particular description (e.g., containers 152A-B belonging to container pod 150, or containers 160A-G all being copies of the same container). In an example, a search for similar containers to 160A conducted on zone 222 may return containers 160F-G. In an example, an inverse search may also be conducted on each level of specificity. For example, searching for containers system wide similar to container 160A, at the node level, may return nodes 112, 116, 230, 234, 238, and 248. Similarly, searching for containers system wide similar to container 160A at the subzone level may return subzones 135, 137, 232, 234, and 236, with only subzone 230 excluded as not having a copy of container 160A executing. In an example, the scheduler 140 may output a list of each container of a plurality of containers (e.g., containers providing a distributed service) associated with a node, a hardware device, a subzone and/or a zone based on an input of an identifier of the node, the hardware device, the subzone and/or the zone.

A first affinity value of a first container of a plurality of containers quantifying the first container's hierarchical relationship to other containers of the plurality of containers deployed on the plurality of nodes is measured, where the plurality of containers is configured to deliver a distributed service (block 315). In an example, the scheduler 140 calculates an affinity value for container 160A based on the hierarchical map of system 200. In an example, the affinity value may be a numerical representation of the distance in the hierarchical map between container 160A and the nearest container of the same type as container 160A on the hierarchical map. In a simplified example, where an affinity value is based only on the relationship between a container and its closest hierarchical relative, an affinity value may be calculated based on the number of shared layers between two containers. For example, containers 160A-B are both deployed on node 112, and therefore containers 160A-B share node 112, hardware device 110A, subzone 135 and zone 130, resulting in an affinity value of 4 for 4 shared layers. Using the same calculation method, container 160F's closest relative may be container 160G, but they may only share zone 222, and may therefore only have an affinity value of one for one shared layer. Similarly, container 160D and container 160E may share subzone 232 and zone 220, and therefore have an affinity value of two. In some examples, more complex affinity calculations may be performed that factor in a container's relationships with containers throughout the system 200 rather than only the container's closest relative. For example, an aggregate score may be calculated for container 160A to each of containers 160B-G. In an example, an affinity value based on an aggregate score may be based on a geometric mean or weighted average of the relationship between container 160A and each of containers 160B-G. In an example, a geometric mean or weighted average may adjust for, or give additional weight to the sharing of a particular layer over another. For example, a higher weight may be given to sharing a node than a zone. A second affinity value of a second container of the plurality of containers quantifying the second container's hierarchical relationship to other containers of the plurality of containers is measured (block 320). In an example, the scheduler 140 may also calculate an affinity value for container 160C, which may be zero as container 160C does not share a node, hardware device, subzone or zone with any other related container. In an example, each layer may be weighted differently for affinity calculations (e.g., sharing a zone may be a higher point value than sharing a node).

A first affinity distribution of the distributed service is calculated based on a first plurality of affinity values including at least the first affinity value and the second affinity value (block 325). In an example, the scheduler 140 may calculate an affinity distribution of a distributed service including containers 160A-G, including the affinity values calculated for containers 160A and 160C. Using the simplified calculation above, it may be determined that containers 160A-B have affinity values of four, container 160C has an affinity value of zero, containers 160D-E have affinity values of two, and containers 160F-G have affinity values of one. In an example, the entire affinity distribution may be represented by numerical value aggregating the affinity values of containers 160A-G, (e.g., 2×4+1×0+2×2+2×1=14, 14/7=2, for a mean of 2). In an example where affinity values for containers delivering a given distributed service are arranged in a relatively normal distribution, a mean value may adequately represent the affinity distribution. In an example, a mean may be improper as a representative value for an affinity distribution where the affinity values representing the affinity distribution are non-normal (e.g., bimodal or multimodal). For example, in a system where fault tolerance is emphasized, one mode may occur with affinity values of zero or one, due to spreading the container deployments as much as possible across zones and subzones. However, due to synergistic advantages related to cohosting containers of the distributed service on a node with another copy of the container already running, a second mode may occur at an affinity value of 4. In an example, ten containers may be deployed across four zones, where three containers are deployed on a shared node in each of the first three zones, and the last container is deployed by itself in the fourth zone. In the example, nine of the containers would have affinity values of four while the last container would have an affinity value of zero. In such an example, the mode (e.g, four) of the affinity values may be representative of the affinity distribution. In another example relating to containers 160 A-G above, the affinity distribution may be a curve representing the data points for each affinity value, (e.g., by graphing affinity value vs. number of occurrences, resulting in a curve with 1-0, 2-1s, 2-2s, 0-3s, and 2-4s). In an example, an affinity distribution may be represented by a count of the occurrences of individual affinity values, (e.g., 1-2-2-0-2 for the system 200 and containers 160A-G above).

A first value of a performance metric of the distributed service while configured in the first affinity distribution is calculated (block 330). The scheduler 140 may calculate a value of a performance metric of the distributed service provided by containers 160A-G. In an example, a performance metric may be a weighted aggregate of a plurality of measurable performance criteria of the distributed service. In an example, a performance criterion may be measured by the scheduler 140 or another component of system 200, and may have either a positive or negative quantitative impact on the first value of the performance metric. For example, performance criteria may include attributes such as latency of the distributed service, execution speed of requests to the distributed service, memory consumption of the distributed service, processor consumption of the distributed service, energy consumption of the distributed service, heat generation of the distributed service, and fault tolerance of the distributed service. In an example, high latency may reduce the value of the performance metric of the distributed service, while high fault tolerance may increase the value of the performance metric of the distributed service. In an example, the relative weights of the performance criterion aggregated in a performance metric may be user configurable. In another example, the relative weights of the performance criterion may be learned by the system through iterative adjustments and testing.

The first value of the performance metric is iteratively adjusted by repeatedly terminating and redeploying containers, measuring affinity values, and calculating affinity distributions and new values of a performance metric as discussed in more detail below (block 335). Containers of the plurality of containers including the first container and the second container are terminated (block 340). In an example, scheduler 140 may terminate containers 160A-B to test if deploying containers 160A-B in a different location of the hierarchical map, resulting in a different affinity distribution for the distributed service, may be beneficial for the value of the performance metric of the distributed service. In another example, a higher proportion of the containers 160A-G may be terminated for the test to, for example, provide more data points for faster optimization. In an example, all of the containers for a given distributed service (e.g., containers 160A-G) may be terminated. In an example, an iteration of termination and testing may be triggered by the failure of one or more containers providing the distributed service (e.g., container 160A failing and self-terminating).

Containers of the plurality of containers including the first container and the second container are redeployed (block 341). In an example, the scheduler 140 may then redeploy any containers providing the distributed service that were terminated. In an example, the scheduler 140 may systematically redeploy the containers providing the distributed service to provide more data points more quickly in the testing process. For example, the scheduler 140 may deploy containers in a manner where each container's affinity value is increased as a result of the redeployment where possible. In an example, containers 160D and 160E may have an affinity value of two prior to redeployment, but may be redeployed sharing a hardware device (e.g., hardware device 210D), with container 160D being redeployed on node 230, and container 160E being redeployed on node 232, thereby resulting in a new affinity value of 3. In an example, the redeployed copies of container 160D and container 160E may both have affinity values higher than or greater than the original copies of container 160D and container 160E.

Affinity values of the plurality of containers, including at least a first new affinity value of a first redeployed container and a second new affinity value of a second redeployed container, are measured (block 342). After redeploying the containers providing the distributed service, the scheduler 140 measures new affinity values of the redeployed containers. In an example, the new affinity values are measured with the same measurement scale as the measurements for containers 160A-G prior to redeployment.

A new affinity distribution of the plurality of containers is calculated (block 343). In an example, scheduler 140 calculates a new affinity distribution of the plurality of containers (e.g., redeployed containers 160A-G) providing the distributed service with newly measured affinity values. In an example, the scheduler 140 may redeploy the containers with higher or lower affinity values than in the original deployment. In an example, the scheduler 140 may redeploy the containers based on an affinity distribution or set of affinity distributions for testing purposes. For example, an affinity distribution where every zone has at least one copy of a container may be chosen to increase the fault tolerance criterion of the distributed service. In an example, the nodes within a zone where containers are deployed may be progressively consolidated in each redeployment cycle to increase any synergies in sharing resources between containers. In another example, the nodes within a zone where containers are deployed may be progressively spread out each redeployment cycle among different subzones and hardware devices to spread out the compute load of the containers to reduce contention for system resources.

A new value of the performance metric of the distributed service while configured in the new affinity distribution is calculated (block 344). In an example, the scheduler 140 calculates a new value of the performance metric of the distributed service while configured in the new affinity distribution by, for example, taking measurements of the performance criterion used to calculate the original value of the performance metric. In an example, each redeployment of the distributed service is allowed to operate continuously until a representative sample of data may be measured for each performance criterion used to calculate the value of the performance metric. In an example, the amount of time necessary to obtain a representative sample of data may depend on the frequency of requests to the distributed service. For example, a highly used distributed service may process tens, hundreds, even thousands of requests in a minute, in which case sufficient data may be collected regarding the performance of the various containers as deployed in a given affinity distribution in thirty seconds to five minutes of time. In an example, after sufficient data is collected, another cycle of refinement may begin by terminating a plurality of the containers providing the distributed service.

Based on the above discussed iterative adjustments, at least a second value of the performance metric and a third value of the performance metric of the distributed service are calculated, where the second value of the performance metric corresponds to a second affinity distribution and the third value of the performance metric corresponds to a third affinity distribution (block 345). In an example, the scheduler 140 terminates and redeploys containers providing the distributed service (e.g., containers 160A-G) at least twice to calculate a second and third value of the performance metric, corresponding to a second and a third affinity distribution. In an example, the original affinity distribution may be a graphical curve representing the data points for each affinity value of containers 160A-G, (e.g., by graphing affinity value vs. number of occurrences, resulting in a curve with 1-0, 2-1s, 2-2s, 0-3s, and 2-4s). In an example, a second affinity distribution may result from redeploying the same seven containers to nodes 112, 116, 212, 230, 232, 238, and 240, resulting in an affinity distribution with 2-0s, 1-1, 0-2s, 4-3s, and 0-4s. In an example, the second affinity distribution may have resulted from the scheduler 140 testing an affinity distribution based on affinity values of three. In an example, a third affinity distribution may result in redeploying the same seven containers to nodes 112, 230, and 240, for example, two copies of the container to node 112, two copies of the container to node 230 and three copies of the container to node 240, resulting in an affinity distributions with 7-4s and no 0s, 1s, 2s, or 3s. In an example, the third affinity distribution may have resulted from the scheduler 140 testing an affinity distribution based on affinity values of four.

It is determined whether the third value of the performance metric is higher than the first value of the performance metric and the second value of the performance metric (block 350). The scheduler 140 may review measured data, including the first, second and third values of the performance metric, to determine whether the third value of the performance metric is greater than the first and second values. In an example, the third value of the performance metric may be determined to be higher than the first and second value without being numerically higher than the first and second values, if for example, a lower value represents a more optimal performance metric. In an example, the third performance metric may benefit from a higher score on a performance criterion such as memory consumption and execution speed from a more closely clustered affinity distribution benefiting from containers sharing nodes and thus sharing memory resources (e.g., shared libraries between the containers may be pre-loaded increasing execution speed and decreasing memory consumption). In the example, the third value of the performance metric may have lower values for a performance criteria such as fault tolerance than the first value of the performance metric, but the scheduler 140 may determine based on the weighting criteria of the individual performance criteria that the third value of the performance metric is higher than the first value of the performance metric overall.

Responsive to determining that the third value of the performance metric is higher than the first value of the performance metric and the second value of the performance metric, deploy the distributed service based on the third affinity distribution (block 355). The scheduler 140 may determine that the optimal value of the performance metric for the distributed service results from an affinity distribution based on high affinity values, such as the third affinity distribution, and deploy the distributed service based on the third affinity distribution. In an example, any additional containers added to the distributed service are added according to the third affinity distribution. For example, the scheduler 140 may be requested to deploy three additional containers to the distributed service, and may deploy all three new containers to node 116 to achieve affinity values of 4 for the new containers. In an example, the scheduler 140 may be requested to deploy a new copy of the same distributed service as the distributed service provided by containers 160A-G, and may deploy containers for the new distributed service with affinity values of 4 to achieve a similar value of a performance metric for the new distributed service as for the distributed service provided by containers 160A-G. In an example, a related distributed service provided by different types of containers than containers 160A-G may be deployed according to the third affinity distribution by scheduler 140. In the example, the related distributed service may not have undergone similar optimization and the third affinity distribution may be used as a baseline to compare iterative test results for the distribution of the related distributed service. In an example, the scheduler 140 may calculate an updated hierarchical map of the system 200 after new hardware is deployed, or after virtual machine nodes are re-provisioned in a different configuration. In the example, the scheduler 140 may redeploy the distributed service provided by containers 160A-G in the new nodes represented in the updated hierarchical map according to the third affinity distribution (e.g., deploying containers with affinity values of four). In an example, redeployment of the distributed service with the same affinity distribution results in a similar value of the performance metric for the distributed service after redeployment as the value of the performance metric for the distributed service in the original deployment of containers with the third affinity distribution.

In an example, the weighting given to a particular performance criterion in calculating a value of a performance metric may be adjusted due to observed circumstances. For example, in the example third affinity distribution above, with two copies of the container deployed to node 112, two copies of the container deployed to node 230 and three copies of the container deployed to node 240, a failure of zone 222, subzone 234, hardware device 210E, or node 240 may result in a large decrease in the value of the performance metric of the distributed service provided by the containers. In an example, fault tolerance may be a performance criterion used to calculate the value of the performance metric of the distributed service. In an example, the weighted value for the fault tolerance criterion may be increased in the calculation of the value of the performance metric for the distributed service as a result of the failure event, resulting in an affinity value of four no longer providing the highest value of the performance metric for the distributed service. In an example, increasing the weight of the fault tolerance criterion may increase the value of the performance metric of the distributed service for affinity distributions with lower affinity values, because the loss of any one zone, subzone, hardware device or node would result in a lesser impact to the value of the performance metric of the distributed service. In an example, the scheduler 140 may be configured simulate the failure of a zone, subzone, hardware device, or node to test the effect of such a failure on the distributed service. In the example, the weighting of a fault tolerance performance criterion may be adjusted based on the test, and a new affinity distribution may be adopted.

In an example, the scheduler 140 may redeploy the containers providing the distributed service maximizing affinity values of two, and therefore deploy the seven containers providing the distributed service to nodes 212, 218, 224, 230, 234, 238 and 242, yielding an affinity distribution where all seven containers have an affinity value of two (e.g., sharing a subzone with another container but not a hardware device or node). In an example, the scheduler 140 receives a request to deploy two more containers for the distributed service and deploys them to nodes 245 and 250 to allow the new containers to also have an affinity value of two. In an example, after containers have been deployed to nodes 212, 218, 224, 230, 234, 238, 242, 245 and 250, further deployments of containers with affinity values of two may no longer be possible, and any additional containers that need to be deployed may be deployed with a different optimal affinity value. For example, after all possible affinity values of two are used, the scheduler 140 may deploy additional containers to node 112 and node 116 with affinity values of zero to maximize the spread of containers for maximum fault tolerance. In another example, after all possible affinity values of two are used, the scheduler 140 may deploy additional containers to node 212 with an affinity value of four to maximize performance within a fault tolerant environment. In an example, a normal distribution, a bimodal distribution or a multimodal distribution may be the optimal affinity distribution for a distributed service based on the weighting of the performance criterion used to calculate the value of the performance metric for the distributed service. For example, an optimal distribution could result in maximizing affinity values of three, with some affinity values of two and four forming a relatively normal distribution, where sharing hardware devices but not necessarily a node is optimal for performance. In another example, where fault tolerance is desired along with sharing memory, affinity values of two and four may be desirable resulting in a bimodal distribution. In an example, the weight of the fault tolerance performance criterion may be high enough that affinity values of zero are preferable, followed by distributing containers to different subzones within a zone, but then any extra containers may perform best by sharing nodes, resulting in a multimodal affinity distribution of affinity values zero, one, and four.

In an example, affinity values may be fractional or decimal numbers. For example, an affinity value may be calculated based on a container's hierarchical relationship with numerous other containers. In an example system, each container of a distributed service sharing a zone with a given container may add an affinity value of 0.1, each container of a distributed service sharing a subzone with a given container may add an affinity value of 1, each container of a distributed service sharing a hardware device with a given container may add an affinity value of 10, each container of a distributed service sharing a node with a given container may add an affinity value of 100. In such an example illustrated using system 200, a distributed service provided by containers 160A-G may have affinity values of: container 160A—100, container 160B—100, container 160C—0, container 160D—1, container 160E—1, container 160F, 0.1, and container 160G 0.1. In an example, an affinity distribution for the distributed service may be represented by a sum (e.g., 202.2) of the affinity values of the system, which may be representative of the hierarchical relationship between the respective containers.

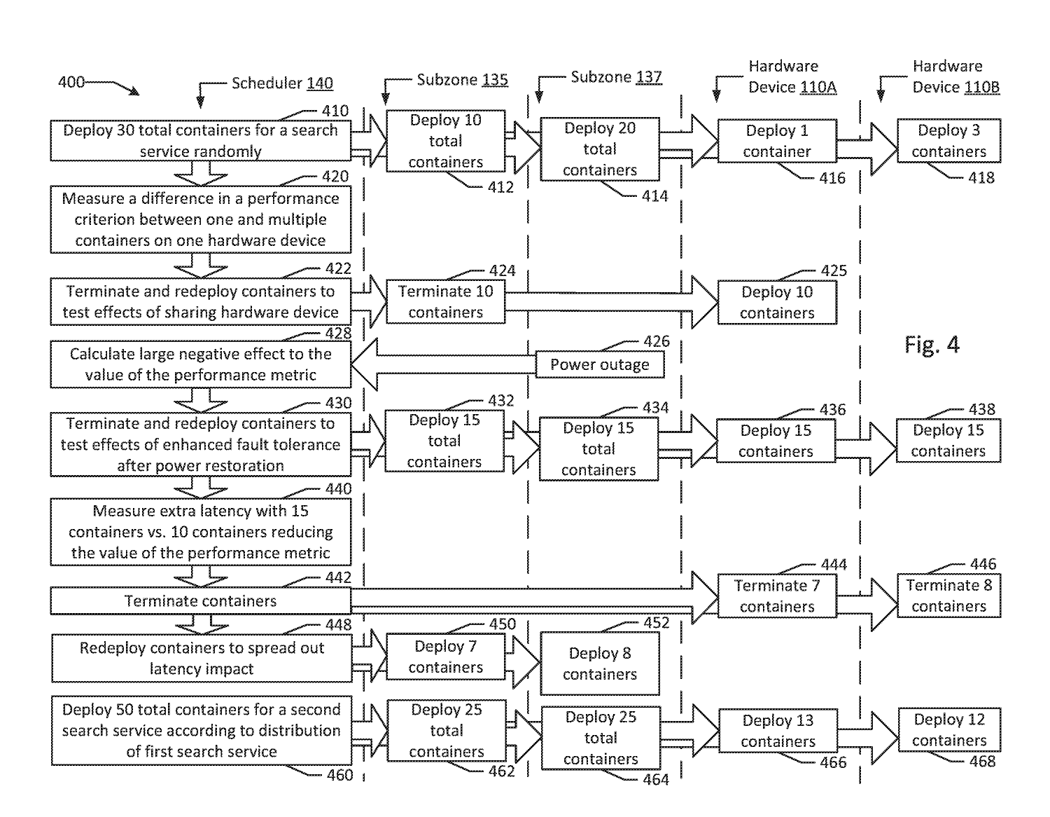

FIG. 4 is a flow diagram illustrating an example system employing affinity based hierarchical container scheduling according to an example of the present disclosure. Although the examples below are described with reference to the flowchart illustrated in FIG. 4, it will be appreciated that many other methods of performing the acts associated with FIG. 4 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 400, a scheduler 140 is in communication with subzones 135 and 137, and hardware devices 110A and 110B.

Scheduler 140 deploys 30 total containers for a search service randomly (block 410). In an example, scheduler 140 receives a request to deploy 30 containers to provide a distributed search service, without any prior data regarding an optimal affinity distribution for the search service. Scheduler 140 may deploy the 30 containers to the first 30 hosting candidates for the containers. For example, ten total containers are deployed in subzone 135 (block 412); twenty total containers are deployed in subzone 135 (block 414). In an example, of the ten containers deployed to subzone 135, one container is deployed on hardware device 110A (block 416). In the example, of the twenty total containers deployed to subzone 137, three containers are deployed on hardware device 110B (block 418). In an example affinity values for each container and an affinity distribution for the search service are calculated by scheduler 140. In a simplified example, containers in system 400 may have either an affinity value of two (e.g., shared zone and subzone) or an affinity value of three (e.g., shared zone, subzone, and hardware device). In the example, the container deployed to hardware device 110A may have an affinity value of two, and the three containers deployed to hardware device 110B may each have an affinity value of three. In an example, an affinity value for a container may be calculated based on an average of numerical, quantitative representations of the container's hierarchical relationship to each other container delivering the same distributed service in the system. For example, in system 400, the three container deployed to hardware device 110B in block 418 may be deployed to two separate nodes. In the example, one of the three containers will have an affinity value of 1.38 based on (2×3 [containers in a different node]+17×2 [containers in subzone 137]+10×0 [containers in subzone 135])/29=1.38. The other two containers may have an affinity value of 1.41 based on (1×4 [container in the same node]+1×3 [containers in a different node]+17×2 [containers in subzone 137]+10×0 [containers in subzone 135])/29=1.4111.

In an example, scheduler 140 measures a difference in a performance criterion between one container and multiple containers hosted on one hardware device (block 420). For example, scheduler 140 may measure that average memory usage of the three containers sharing hardware device 110B is lower than the average memory usage of the one container on hardware device 110A. In an example, memory usage may be lower where a shared library used by the container remains loaded in memory longer due to reuse by another container before the shared library is scheduled to be garbage collected. In an example, scheduler 140 terminates and redeploys containers to test any effects of containers sharing a hardware device on performance criteria (block 422). In the example, ten containers are terminated in subzone 135 (block 424); and ten containers are deployed on hardware device 110A (block 425). In an example, all ten of the containers in subzone 135 are consolidated on hardware device 110A, resulting in significant advantages in memory consumption in subzone 135 after redeployment as compared to before redeployment. In an example, scheduler 140 may determine that sharing a hardware device is an optimal condition for deploying containers for the search service. In a simplified example, the ten containers that were terminated may have had affinity values of two for sharing a subzone, and the affinity value of each of the redeployed containers in hardware device 110A may be three for sharing a hardware device. In an example where affinity value is calculated based on an average value in relation to all of the other containers delivering the distributed service, the affinity value of the ten containers deployed to hardware device 110A in block 425 may differ depending on whether they are deployed on the same node. In an example, the ten containers are all deployed to one node, resulting in an affinity value of 1.24 (9×4 [containers the same node]+20×0 [containers in subzone 137])/29=1.24. In another example, where five containers are deployed to each of two nodes on hardware device 110A a resulting affinity value may be 1.07 (4×4 [containers the same node]+5×3 [containers in a different node]+20×0 [containers in subzone 137])/29=1.07. In an example, the relative affinity levels of sharing different layers may be adjusted to compensate for the effect of many nodes being in different zones. In another example, only containers within the same zone are factored into the affinity value calculation.

In an example, a power outage affects subzone 137 (block 426). A large negative effect is calculated affecting the value of the performance metric of the search service (block 428). For example, because 20 of the 30 containers for the search service were located in subzone 137, two-thirds of the processing capability for the search service was lost when the power outage occurred. In an example, the weight of a fault tolerance performance criterion may be greatly increased as a result of the power failure, either due to user configuration or measured deficiencies in other performance criterion such as latency and response time to requests. As a result, the scheduler 140 may retest for a new optimal affinity distribution. Containers are terminated and redeployed to test the effects of enhanced fault tolerance on the value of the performance metric after power restoration (block 430). In an example, all of the containers for the search service may be terminated. In the example, fifteen total containers are deployed in subzone 135 (block 432); and fifteen total containers are deployed in subzone 135 (block 434). In an example, the memory advantages resulting from sharing a hardware device cause the scheduler 140 to emphasize sharing a hardware device within a subzone. In the example, fifteen containers are deployed on hardware device 110A (block 436); and fifteen containers are deployed on hardware device 110B (block 438). In an example, the affinity values of all thirty containers may have been three both before and after the redeployment based on sharing a hardware device with at least one other container of the search service. In another example, the number of containers a given container shares layers with is taken into account. In an example, the number of containers sharing a given layer may be factored into an affinity distribution calculation. In an example where affinity value is calculated based on an average value in relation to all of the other containers delivering the distributed service, the affinity value of the fifteen containers deployed to hardware device 110A in block 436 may differ depending on whether they are deployed on the same node. In an example, the fifteen containers are all deployed to one node, resulting in an affinity value of 1.9 (14×4 [containers the same node]+15×0 [containers in subzone 137])/29=1.93. In another example, where five containers are deployed to each of three nodes on hardware device 110A a resulting affinity value may be 1.59 (4×4 [containers the same node]+10×3 [containers in a different node]+15×0 [containers in subzone 137])/29=1.59.

In an example, the scheduler 140 may determine that the redeployed system is not performing as well as expected based on the affinity distribution of the containers. For example, extra latency is measured with fifteen containers executing on one hardware device compared to 10 containers executing on one hardware device, reducing the value of the performance metric for the search service (block 440). In the example, increasing the number of containers on one hardware device from ten to fifteen resulted in the network bandwidth available to the hardware device becoming a bottleneck for performance. In an example, scheduler 140 terminates containers (block 442). The scheduler 140 may test whether decreasing the number of containers on a shared hardware device may increase performance. For example, seven containers are terminated on hardware device 110A (block 444); and eight containers are terminated on hardware device 110B (block 446). In an example, the terminated containers are then redeployed by scheduler 140 to spread out latency impact (block 448). In an example, seven containers are deployed in subzone 135 (block 45). In an example, the seven containers may be deployed on the same hardware device but not on hardware device 110A. In the example, eight containers are deployed in subzone 137 (block 452). In an example, the eight containers may be deployed on the same hardware device but not on hardware device 110B. In an example where affinity value is calculated based on an average value in relation to all of the other containers delivering the distributed service, the affinity value of the eight containers left on hardware device 110A after the terminations in block 444 and the redeployments in blocks 450 and 452 may differ depending on whether they are deployed on the same node. In an example, the eight containers are all deployed to one node, resulting in an affinity value of 1.45 (7×4 [containers the same node]+7×2 [containers in subzone 135]+15×0 [containers in subzone 137])/29=1.45. In another example, where four containers are deployed to each of two nodes on hardware device 110A a resulting affinity value may be 1.31 (3×4 [containers the same node]+4×3 [containers in a different node]+7×2 [containers in subzone 135]+15×0 [containers in subzone 137])/29=1.31.

In an example, the scheduler 140 may be requested to deploy a second copy of the search service, with fifty total containers. In the example, scheduler 140 deploys fifty total containers for a second copy of the search service according to the affinity distribution of the first search service (block 460). For example, sharing hardware devices is optimal, but at less than fifteen containers on each hardware device, and even spreading of containers across subzones is optimal for fault tolerance. In an example, twenty-five total containers are deployed in subzone 135 (block 462); and twenty-five total containers are deployed in subzone 135 (block 464). In an example, of the twenty-five total containers deployed to subzone 135, thirteen containers are deployed on hardware device 110A (block 466). In an example, of the twenty-five total containers deployed to subzone 137, twelve containers are deployed on hardware device 110B (block 468). In an example, the scheduler 140 may utilize the deployment of the second copy of the search service to further refine an upper limit for the number of containers that may advantageously share a hardware device, testing twelve and thirteen copies of the container sharing the hardware devices 110A-B. In an example, the scheduler 140 may periodically recalculate and retest the optimal affinity distribution for the search service based on factors such as changes in hardware, changes in node distribution, and changes in the number of containers requested for the search service. In an example, a high affinity value may be less advantageous after a certain density of containers is reached on a node or hardware device. In an example where a low affinity value is identified as optimal, for example, to maximize fault tolerance or to maximize local compute resources geographically, additional testing may be needed to determine whether clustering or spreading out containers within a particular zone is optimal once more containers are requested. In an example where affinity value is calculated based on an average value in relation to all of the other containers delivering the distributed service, the affinity value of the twelve containers deployed to hardware device 110B in block 468 may differ depending on whether they are deployed on the same node. In an example, the twelve containers are all deployed to one node, resulting in an affinity value of 1.43 (11×4 [containers the same node]+13×2 [containers in subzone 135]+25×0 [containers in subzone 137])/49=1.43. In another example, where four containers are deployed to each of three nodes on hardware device 110A a resulting affinity value may be 1.31 (3×4 [containers the same node]+8×3 [containers in a different node]+13×2 [containers in subzone 135]+15×0 [containers in subzone 137])/49=1.27. In an example, similar deployment schemes of a larger or smaller plurality of containers may yield similar affinity values for similarly situated containers.

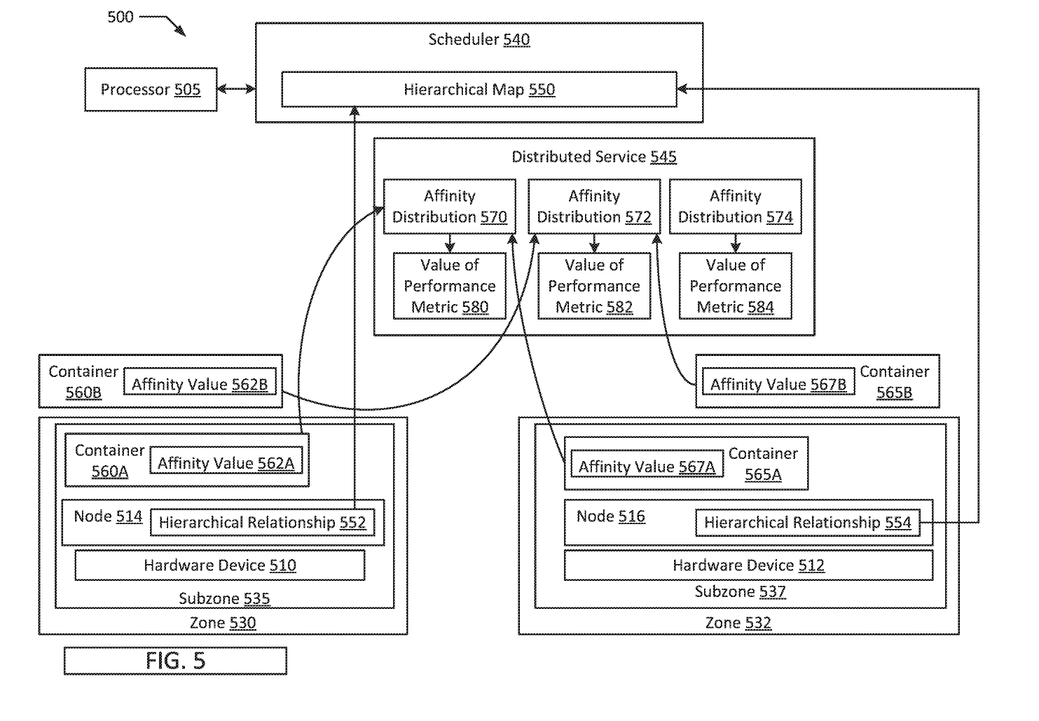

FIG. 5 is a block diagram of an example system employing affinity based hierarchical container scheduling according to an example of the present disclosure. Example system 500 may include a plurality of nodes (e.g., node 514 and node 516) including node 514 and node 516, where node 514 is associated with hardware device 510, which is associated with subzone 535, which is associated with zone 530, and node 516 is associated with hardware device 512, which is associated with subzone 537, which is associated with zone 532. A plurality of containers (e.g., container 560A and container 565A) may be deployed on node 514 and node 516, including container 560A and container 565A, where the plurality of containers (e.g., container 560A and container 565A) is configured to deliver distributed service 545. In an example, distributed service 545 may be any type of computing task that may be deployed as multiple containers. In an example, distributed service 545 may be a microservice.

In an example, a scheduler 540 may execute on processor 505. The scheduler 540 may build hierarchical map 550 of system 500 by identifying hierarchical relationships (e.g., hierarchical relationship 552 and hierarchical relationship 554) between each node (e.g., node 514 or node 516) of the plurality of nodes (e.g., node 514 and node 516) and a respective hardware device (e.g., hardware device 510 and hardware device 512), a respective subzone (e.g., subzone 535 and subzone 537) and a respective zone (e.g., zone 530 and zone 532), associated with each node (e.g., node 514 or node 516) of the plurality of nodes (e.g., node 514 and node 516). In an example, the scheduler 540 measures affinity value 562A of container 560A quantifying container 560A's hierarchical relationship 552 to other containers (e.g., container 565A) of the plurality of containers (e.g., container 560A and container 565A). In an example, the scheduler 540 measures affinity value 567A of container 565A quantifying container 565A's hierarchical relationship 554 to other containers (e.g., container 560A) of the plurality of containers (e.g., container 560A and container 565A). Scheduler 540 may calculate affinity distribution 570 of distributed service 545 based on a plurality of affinity values (e.g., affinity value 562A and affinity value 567A) including at least affinity value 562A and affinity value 567A. The scheduler 540 calculates a value 580 of a performance metric of the distributed service 545 while configured in affinity distribution 570.

The scheduler 540 iteratively adjusts the value 580 of the performance metric by repeatedly: (i) terminating container 560A and container 565A; (ii) redeploying container 560A and container 565A as container 560B and container 565B; (iii) measuring affinity values (e.g., affinity value 562B and affinity value 567B) of the plurality of containers (e.g., container 560B and container 565B) including at least affinity value 562B of container 560B and affinity value 567B of container 565B; (iv) calculating affinity distribution 572 of the plurality of containers (e.g., container 560B and container 565B); and (v) calculating value 582 of the performance metric of distributed service 545 while configured in affinity distribution 572, such that at least value 582 of the performance metric and value 584 of the performance metric of the distributed service 545 are calculated, where value 582 of the performance metric corresponds to affinity distribution 572 and value 584 of the performance metric corresponds to affinity distribution 574. The scheduler 540 determines whether value 584 of the performance metric is higher than value 580 of the performance metric and value 582 of the performance metric. After determining that value 584 of the performance metric is higher than value 580 of the performance metric and value 582 of the performance metric, deploy distributed service 545 based on affinity distribution 574.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system, the system comprising:
a plurality of nodes including a first node and a second node, wherein the first node is associated with a first hardware device, which is associated with a first subzone, which is associated with a first zone, and the second node is associated with a second hardware device, which is associated with a second subzone, which is associated with a second zone;
a plurality of containers deployed on the plurality of nodes, including a first container and a second container, wherein the plurality of containers is configured to deliver a first distributed service;
one or more processors;
a scheduler executing on the one or more processors to:
build a hierarchical map of the system by identifying a hierarchical relationship between each node of the plurality of nodes and a respective hardware device, a respective subzone and a respective zone associated with each node of the plurality of nodes;
measure a first affinity value of the first container quantifying the first container's hierarchical relationship to other containers of the plurality of containers;
measure a second affinity value of the second container quantifying the second container's hierarchical relationship to other containers of the plurality of containers;
calculate a first affinity distribution of the first distributed service based on a first plurality of affinity values including at least the first affinity value and the second affinity value;
calculate a first value of a performance metric of the first distributed service while configured in the first affinity distribution;
iteratively adjusting the first value of the performance metric by repeatedly:
terminating containers of the plurality of containers including the first container and the second container;
redeploying containers of the plurality of containers including the first container and the second container;
measuring affinity values of the plurality of containers including at least a first new affinity value of a first redeployed container and a second new affinity value of a second redeployed container;
calculating a new affinity distribution of the plurality of containers; and
calculating a new value of the performance metric of the first distributed service while configured in the new affinity distribution,
such that at least a second value of the performance metric and a third value of the performance metric of the first distributed service are calculated, wherein the second value of the performance metric corresponds to a second affinity distribution and the third value of the performance metric corresponds to a third affinity distribution;
determine whether the third value of the performance metric is higher than the first value of the performance metric and the second value of the performance metric; and
responsive to determining that the third value of the performance metric is higher than the first value of the performance metric and the second value of the performance metric, deploy the first distributed service based on the third affinity distribution.

2. The system of claim 1, wherein the scheduler identifies at least one of the first node, the first hardware device, the first subzone, and the first zone based on at least one of metadata associated with the first container, a hostname of the first container, and an IP address of the first container.

3. The system of claim 1, wherein the scheduler redeploys the first container and the second container such that the a affinity value of the first redeployed container is a higher value than the first affinity value and a fourth affinity value of the second redeployed container is higher than the second affinity value.

4. The system of claim 1, wherein the third affinity distribution is one of a normal distribution, a bimodal distribution, and a multimodal distribution.

5. The system of claim 1, wherein the first value of the performance metric is calculated with a plurality of performance criteria including at least a first performance criterion and a second performance criterion.

6. The system of claim 5, wherein the first performance criterion is measured, and has one of a positive quantitative impact and a negative quantitative impact on the first value of the performance metric.

7. The system of claim 5, wherein the first performance criterion is one of latency, execution speed, memory consumption, processor consumption, energy consumption, heat generation and fault tolerance.

8. The system of claim 5, wherein a failure event renders at least one of a hardware device, a subzone, and a zone unavailable.

9. The system of claim 8, wherein the first performance criterion is fault tolerance, and the first value of the performance metric is lowered due to a disproportionate impact on the first distributed service caused by the failure event.

10. The system of claim 9, wherein the first container and the second container are redeployed based on a fourth affinity distribution.

11. The system of claim 1, wherein the first container at least one of fails and malfunctions, and the scheduler redeploys the first container based on the third affinity distribution.

12. The system of claim 1, wherein each containers of the plurality of containers is terminated and redeployed prior to calculating one of the new affinity distribution.

13. The system of claim 1, wherein containers of the plurality of containers are terminated and redeployed systematically.

14. The system of claim 1, wherein the scheduler outputs a list of each container of the plurality of containers associated with at least one of a node, a hardware device, a subzone, and a zone based on an input of an identifier of at least one of the node, the hardware device, the subzone, and the zone.

15. The system of claim 1, wherein the first new affinity value of the first redeployed container is higher than the first affinity value.

16. The system of claim 1, wherein a new copy of the first distributed service is deployed based on the third affinity distribution.

17. The system of claim 1, wherein a second distributed service related to the first distributed service is deployed based on the third affinity distribution.

18. The system of claim 1, wherein the scheduler deploys the first distributed service in a second plurality of nodes with a different hierarchical map based on the third affinity distribution.

19. A method, the method comprising:
building a hierarchical map of a system by identifying a hierarchical relationship between each node of a plurality of nodes and a respective hardware device, a respective subzone and a respective zone associated with each node of the plurality of nodes;
measuring a first affinity value of a first container of a plurality of containers quantifying the first container's hierarchical relationship to other containers of the plurality of containers deployed on the plurality of nodes, wherein the plurality of containers is configured to deliver a distributed service;
measuring a second affinity value of a second container of the plurality of containers quantifying the second container's hierarchical relationship to other containers of the plurality of containers;
calculating a first affinity distribution of the distributed service based on a first plurality of affinity values including at least the first affinity value and the second affinity value;
calculating a first value of a performance metric of the distributed service while configured in the first affinity distribution;
iteratively adjusting the first value of the performance metric by repeatedly:
terminating containers of the plurality of containers including the first container and the second container;
redeploying containers of the plurality of containers including the first container and the second container;
measuring affinity values of the plurality of containers including at least a first new affinity value of a first redeployed container and a second new affinity value of a second redeployed container;
calculating a new affinity distribution of the plurality of containers; and
calculating a new value of the performance metric of the distributed service while configured in the new affinity distribution,
such that at least a second value of the performance metric and a third value of the performance metric of the distributed service are calculated, wherein the second value of the performance metric corresponds to a second affinity distribution and the third value of the performance metric corresponds to a third affinity distribution;
determining whether the third value of the performance metric is higher than the first value of the performance metric and the second value of the performance metric; and
responsive to determining that the third value of the performance metric is higher than the first value of the performance metric and the second value of the performance metric, deploy the distributed service based on the third affinity distribution.

20. A computer-readable non-transitory storage medium storing executable instructions which when executed by a computer system, cause the computer system to:
build a hierarchical map of a system by identifying a hierarchical relationship between each node of a plurality of nodes and a respective hardware device, a respective subzone and a respective zone associated with each node of the plurality of nodes;
measure a first affinity value of a first container of a plurality of containers quantifying the first container's hierarchical relationship to other containers of the plurality of containers deployed on the plurality of nodes, wherein the plurality of containers is configured to deliver a distributed service;
measure a second affinity value of a second container of the plurality of containers quantifying the second container's hierarchical relationship to other containers of the plurality of containers;
calculate a first affinity distribution of the distributed service based on a first plurality of affinity values including at least the first affinity value and the second affinity value;
calculate a first value of a performance metric of the distributed service while configured in the first affinity distribution;
iteratively adjust the first value of the performance metric by repeatedly:
terminating containers of the plurality of containers including the first container and the second container;
redeploying containers of the plurality of containers including the first container and the second container;
measuring affinity values of the plurality of containers including at least a first new affinity value of a first redeployed container and a second new affinity value of a second redeployed container;
calculating a new affinity distribution of the plurality of containers; and
calculating a new value of the performance metric of the distributed service while configured in the new affinity distribution,
such that at least a second value of the performance metric and a third value of the performance metric of the distributed service are calculated, wherein the second value of the performance metric corresponds to a second affinity distribution and the third value of the performance metric corresponds to a third affinity distribution;
determine whether the third value of the performance metric is higher than the first value of the performance metric and the second value of the performance metric; and
responsive to determining that the third value of the performance metric is higher than the first value of the performance metric and the second value of the performance metric, deploy the distributed service based on the third affinity distribution.
